(19) United States
(12) Patent Application Publication
(10) Pub. No.: US 2009/0127896 A1
(43) Pub. Date: May 21, 2009

(54) Infant Feeding Bottle Holder

(76) Inventor: Debra L. Madden, Arcadia, FL (US)

Correspondence Address: ADVANTIA LAW GROUP, 9035 SOUTH 1300 EAST, SUITE 200, SANDY, UT, 84094, US

(21) Appl. No.: 11/942,418

(22) Filed: Nov. 19, 2007

(51) Int. Cl. A47D 15/00; A61J 9/06

(52) U.S. Cl. 297/188.01; 248/102

(57) ABSTRACT

An infant feeding bottle holder apparatus at least includes: an adjustable mounting structure at least including a middle section, first and second end sections coupled to the middle section, and first and second clamp sections coupled to the ends of the first and second end sections, respectively; and a feeding bottle arm adapted to be coupled at a first end to the middle section, and adapted to be coupled at a second end to a feeding bottle. The first and second end sections are adapted to couple the infant feeding bottle holder apparatus to an apparatus in which an infant sits or lies. A feeding bottle operatively coupled to the feeding bottle arm may be positioned to allow the infant to autonomously drink from the feeding bottle.

### BACKGROUND OF THE INVENTION

1. Field of the Invention

The present invention generally relates to bottle holders, and specifically relates to bottle holders suitable for holding infant feeding bottles.

2. Description of the Related Art

Infants require almost constant attention to have their basic needs met. This is certainly the case with regard to providing infants with bottles for liquid nourishment. There are times, however, when parents and other caregivers may find it inconvenient if not very difficult and dangerous to timely provide infant bottle feedings for their young. Such difficult times include driving an automobile when there is no caregiver other than the driver in the automobile. There are other difficult times such as when the infant is being transported in a stroller and there is no convenient time or place to provide a normal bottle feeding. In yet other circumstances, parents and other caregivers could benefit from providing a way for infants to receive a bottle feeding while the parent or caregiver is free for brief periods to perform other nearby tasks.

Younger infants are sometimes barely able to hold feeding bottles on their own, and older infants are prone to dropping or throwing feeding bottles.

What is therefore desirable is a way to provide an infant feeding bottle holder that attaches to infant car seats, strollers and the like. Some prior art approaches include attaching flexible bottle holder arms that pivot, such as disclosed in U.S. Pat. No. 5,727,842 (issued to O'Neil), or providing special straps that attach to infant seats, such as disclosed in U.S. Pat. No. 4,630,793 (issued to Hunter) and U.S. Patent Application Publication Number 2004/0140407 (Morris, et al.). Generally, the aforementioned prior art approaches are either marginally effective or ineffective in the case where the infant drops the feeding bottle from his or her hands since the bottle is then out of the infant's reach or requires advanced dexterity that the infant may not possess.

Still other approaches mount special holder arm devices to the infant seat, but require the seat to have special couplers or special manufactured voids to accept the arms. Such is the approach, for example, of U.S. Pat. No. 6,006,972 (issued to O'Neill) and U.S. Design Pat. No. 353,462 (issued to McBeth). U.S. Pat. No. 5,927,661 (issued to Tinsley, et al.) has perhaps an improved strap approach, but requires that a pre-manufactured bulk-head type device already be attached to the infant seat.

With the above-mentioned approaches of the prior art, there is still a need to provide a simple apparatus which is widely adaptable to fit infant seats, strollers and the like, without special pre-manufactured coupling devices or voids, and in which once adjusted, an attached feeding bottle is conveniently within the reach of the feeding infant.

### SUMMARY OF THE INVENTION

The present invention has been developed in response to the present state of the art, and in particular, in response to the problems and needs in the art that have not yet been fully solved. Accordingly, the present invention has been developed to provide an improved infant feeding bottle holder.

In one embodiment of the invention, the infant feeding bottle holder apparatus at least includes: an adjustable mounting structure at least including a middle section, first and second end sections coupled to the middle section, and first and second clamp sections coupled to the ends of the first and second end sections, respectively; and a feeding bottle arm adapted to be coupled at a first end to the middle section, and adapted to be coupled at a second end to a feeding bottle. The first and second end sections are adapted to couple the infant feeding bottle holder apparatus to an apparatus in which an infant sits or lies. Consequently, a feeding bottle operatively coupled to the feeding bottle arm may be positioned to allow the infant to autonomously drink from the feeding bottle.

In another embodiment of the invention, the middle section further at least includes a slotted teeth section adapted to accept the first end of the feeding bottle arm, and allow horizontal displacement of the coupling point.

In yet another embodiment of the invention, the second end of the feeding bottle arm further at least includes a strap coupler adapted to strap a feeding bottle to the feeding bottle arm.

In still yet another embodiment of the invention, the first and second end sections are adjustably coupled to the middle section to allow the middle section to be rotated about the end sections, to change the angle of the middle section about its longitudinal axis, and hence change the position of a feeding bottle coupled to a mounted feeding bottle arm.

In a further embodiment of the invention, the first and second clamp sections are rotatably coupled to the first and second end members, respectively.

In yet a further embodiment of the invention, the middle section is expandable along its longitudinal axis.

In still a further embodiment of the invention, the middle section further at least includes a slotted teeth section adapted to accept the first end of the feeding bottle arm, and allow horizontal displacement of the coupling point, wherein the second end of the feeding bottle arm further at least includes a strap coupler adapted to strap a feeding bottle to the feeding bottle arm, wherein the first and second end sections are adjustably coupled to the middle section to allow the middle section to be rotated about the end sections, to change the angle of the middle section about its longitudinal axis, and hence change the position of a feeding bottle coupled to a mounted feeding bottle arm, and wherein the first and second clamp sections are rotatably coupled to the first and second end members.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric view of an infant feeding bottle holder, according to one embodiment of the invention; and

FIG. 2 is a side view of the slotted teeth section of the adjustable mounting structure, and the feeding bottle arm, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

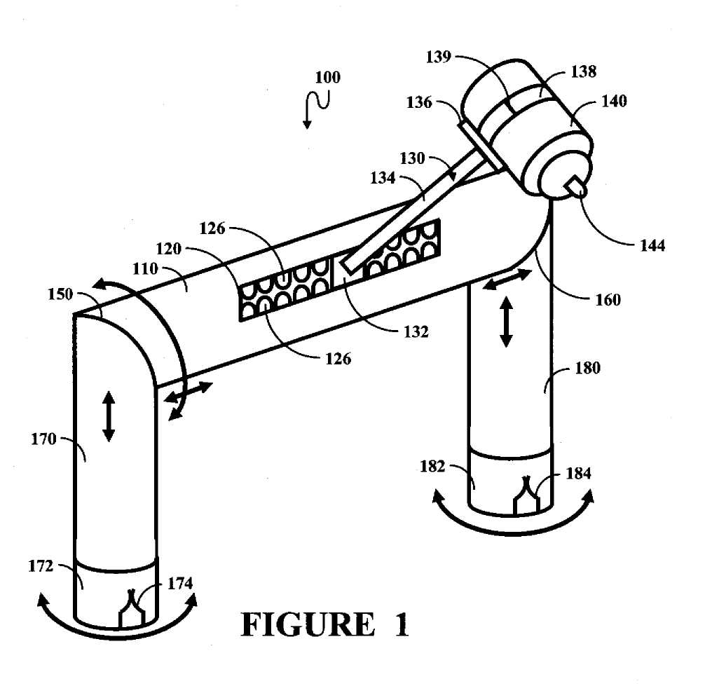

FIG. 1 illustrates one embodiment of the infant feeding bottle holder apparatus 100 for holding an infant bottle in a convenient location to allow an infant to receive bottle nourishment without the need for a caregiver to hold the feeding bottle. The apparatus 100 generally consists of an adjustable mounting structure and a feeding bottle arm 130. The feeding bottle arm may be either rigid or semi-rigid. The adjustable mounting structure includes a middle section 110, which can be swiveled or rotated around joints 150 and 160, and end sections 170 and 180, which are joined to the middle section 110 via the joints 150 and 160, respectively.

The end sections 170 and 180 have at their ends, rotatable clamp sections 172 and 182, respectively, which clamp sections can clamp the infant feeding bottle holder apparatus 100 to an infant seat, stroller, or the like via clamps 174 and 184.

One end of the feeding bottle arm has a strap coupler for strapping a feeding bottle 140 to the feeding bottle arm 130. The strap coupler has a bottle mount 136 upon which the feeding bottle rests, and a flexible strap 138. The flexible strap 138 has Velcro fasteners 139 to allow one end of the strap 139 to be connected to the other end of the strap to snuggly hold the feeding bottle 140. The flexible strap can be constructed of any suitable material that provides flexibility with the necessary strength for holding typical infant feeding bottles. In the example shown, the infant feeding bottle 140 includes a nipple 144, through which a feeding infant can swallow the nourishing liquid.

The middle section 110 also includes a slotted teeth section 120 which securely couples the middle section 110 to the feeding bottle arm 130 at its bottle arm coupler 132. The interplay of the bottle arm coupler 132 and a number of slotted teeth 126, allows the feeding bottle arm 130 to be moved to several fixed horizontal locations.

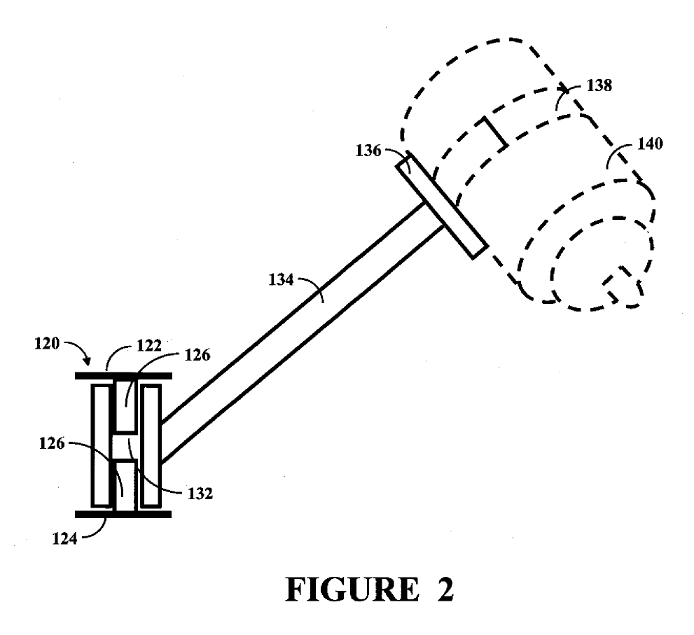

Turning to FIG. 2, which is a side view of the slotted teeth section 120 and the bottle arm coupler 132, it can be seen that the bottle arm coupler 132 is held securely in place between slotted teeth 126 to provide horizontal positioning. A user can move the feeding bottle arm 130 to a new horizontal location by sliding the coupler 132 between the interfering, but flexible teeth, until the desired position is reached. The interplay of the coupler 132 and ledges 122 and 124 of the slotted teeth section 120 provides for additional Torsional integrity of the apparatus 100 with respect to the longitudinal axis of the middle section 110.

The rotating clamp sections 172 and 182 allow the infant feeding holder apparatus 100 to be clamped onto surfaces which do not need to be parallel. The middle section 110 can be rotated about the joints to provide for flexible angular positioning of the feeding bottle 140. In one embodiment of the invention, the end sections 170 and 180 are expandable to provide different heights, such as, for example, between ten and twelve inches. This may be accomplished in a variety of ways, including the use of two or more telescopic members.

Also, in an embodiment of the invention the middle section 110 is expandable to accommodate different seat widths, such as, for example, between twenty-four and twenty-six inches. This may also be accomplished in a variety of ways, including the use of two or more telescopic members.

The interplay of the joints 150 and 160, and the middle section 110, can provide an interference fit with enough friction to securely maintain a chosen rotational position of the middle section. In a non-limiting alternative, the aforementioned interplay can utilize serrations, cogs or other devices to allow the rotation to have fixed positions.

The components of the invention can be constructed of many suitable materials, including, but not limited to, plastic, metal, composites, and combinations of these.

With the above description, an infant can drink from a feeding bottle 140 which is within an optimum range of locations relative to his mouth, and without the need for caregiver intervention once the apparatus 100 is properly adjusted and fastened.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Finally, it is envisioned that the components of the system may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An infant feeding bottle holder apparatus comprising:
an adjustable mounting structure comprising a middle section, first and second end sections coupled to said middle section, and first and second clamp sections coupled to the ends of said first and second end sections, respectively; and
a feeding bottle arm adapted to be coupled at a first end to said middle section, and adapted to be coupled at a second end to a feeding bottle;
wherein said first and second end sections are adapted to couple said infant feeding bottle holder apparatus to an apparatus in which an infant sits or lies, and wherein a feeding bottle operatively coupled to said feeding bottle arm may be positioned to allow said infant to autonomously drink from said feeding bottle.

2. The infant feeding bottle holder apparatus of claim 1, wherein said middle section further comprises a slotted teeth section adapted to accept the first end of said feeding bottle arm, and allow horizontal displacement of the coupling point.

3. The infant feeding bottle holder apparatus of claim 1, wherein the second end of said feeding bottle arm further comprises a strap coupler adapted to strap a feeding bottle to said feeding bottle arm.

4. The infant feeding bottle holder apparatus of claim 1, wherein said first and second end sections are adjustably coupled to said middle section to allow the middle section to be rotated about the end sections, to change the angle of the middle section about its longitudinal axis, and hence change the position of a feeding bottle coupled to a mounted feeding bottle arm.

5. The infant feeding bottle holder apparatus of claim 1, wherein said first and second clamp sections are rotatably coupled to said first and second end members, respectively.

6. The infant feeding bottle holder apparatus of claim 1, wherein said middle section is expandable along its longitudinal axis.

7. The infant feeding bottle holder apparatus of claim 1, wherein said middle section further comprises a slotted teeth section adapted to accept the first end of said feeding bottle arm, and allow horizontal displacement of the coupling point, wherein the second end of said feeding bottle arm further comprises a strap coupler adapted to strap a feeding bottle to said feeding bottle arm, wherein said first and second end sections are adjustably coupled to said middle section to allow the middle section to be rotated about the end sections, to change the angle of the middle section about its longitudinal axis, and hence change the position of a feeding bottle coupled to a mounted feeding bottle arm, and wherein said first and second clamp sections are rotatably coupled to said first and second end members.

8. An infant feeding bottle holder apparatus consisting essentially of:
an adjustable mounting structure consisting essentially of a middle section, first and second end sections coupled to said middle section, and first and second clamp sections coupled to the ends of said first and second end sections, respectively; and
a feeding bottle arm adapted to be coupled at a first end to said middle section, and adapted to be coupled at a second end to a feeding bottle;
wherein said first and second end sections are adapted to couple said infant feeding bottle holder apparatus to an apparatus in which an infant sits or lies, and wherein a feeding bottle operatively coupled to said feeding bottle arm may be positioned to allow said infant to autonomously drink from said feeding bottle.

9. An infant feeding bottle holder apparatus consisting of:
an adjustable mounting structure consisting of a middle section, first and second end sections coupled to said middle section, and first and second clamp sections coupled to the ends of said first and second end sections, respectively; and
a feeding bottle arm adapted to be coupled at a first end to said middle section, and adapted to be coupled at a second end to a feeding bottle;
wherein said first and second end sections are adapted to couple said infant feeding bottle holder apparatus to an apparatus in which an infant sits or lies, and wherein a feeding bottle operatively coupled to said feeding bottle arm may be positioned to allow said infant to autonomously drink from said feeding bottle.
